(19) United States
(12) Patent Application Publication
(10) Pub. No.: US 2022/0161806 A1
(43) Pub. Date: May 26, 2022

(54) OPERATING DEVICE, VEHICLE AND METHOD FOR OPERATING A VEHICLE

(71) Applicant: ZF Friedrichshafen AG, Friedrichshafen (DE)

(72) Inventors: Lenard Petrzik, Osnabrück (DE); Alex Hessel, Lemförde (DE); Ludger Rake, Steinfeld (DE)

(73) Assignee: ZF Friedrichshafen AG, Friedrichshafen (DE)

(21) Appl. No.: 17/441,594

(22) PCT Filed: Mar. 19, 2020
(86) PCT No.: PCT/EP2020/057658

§ 371 Date: Sep. 21, 2021

(30) Foreign Application Priority Data
Mar. 21, 2019 (DE) 10 2019 203 840.9

(51) Int. Cl. B60W 40/105; B60W 30/18; F16D 37/02

(52) U.S. Cl. CPC B60W 40/105; B60W 2300/36; F16D 37/02; B60W 30/18109

(57) ABSTRACT

An operating device for a vehicle has a handle and an actuator device that comprises a magnetorheological medium, which is coupled to the handle and is designed to exert a setting force on the handle that is dependent on a viscosity of the magnetorheological medium.

### RELATED APPLICATIONS

This application is a filing under 35 U.S.C. § 371 of International Patent Application PCT/EP2020/057658, filed Mar. 19, 2020, and claiming priority to German Patent Application 10 2019 203 840.9, filed Mar. 21, 2019. All applications listed in this paragraph are hereby incorporated by reference in their entireties.

### TECHNICAL FIELD

The present disclosure relates to an operating device for a vehicle, a vehicle, in particular a motorcycle, and a method for operating a vehicle.

### BACKGROUND

Rotating accelerator handles are used, for example, in motorcycles as an operating element for controlling the engine output by hand.

Based on this, the present invention results in an improved operating device for a vehicle, an improved vehicle, and an improved method for operating a vehicle.

### BRIEF DESCRIPTION OF THE DRAWINGS

Certain embodiments shall be explained in greater detail in reference to the drawings. Therein:

FIG. 1 shows a vehicle with an operating device according to an exemplary embodiment.

FIG. 2 shows a side view of an operating device according to an exemplary embodiment.

FIG. 3 shows an illustration of an operating device according to an exemplary embodiment.

FIG. 4 shows an illustration of a movement of the handle on an operating device according to an exemplary embodiment.

FIG. 5 shows a curve for a setting force for an operating device as a function of the vehicle speed according to an exemplary embodiment.

FIG. 6 shows a curve for a setting force for an operating device as a function of the vehicle's speed according to an exemplary embodiment.

FIG. 7 shows a curve for a setting force for an operating device as a function of the rotational rate of the engine according to an exemplary embodiment.

FIG. 8 shows a curve for a setting force for an operating device as a function of the rotational rate of the engine according to an exemplary embodiment.

FIG. 9 shows an illustration of a movement of the handle on an operating device according to an exemplary embodiment.

FIG. 10 shows a curve for a setting force for an operating device as a function of the rotational rate of the engine according to an exemplary embodiment.

FIG. 11 shows an illustration of a movement of a handle on an operating device according to an exemplary embodiment.

FIG. 12 shows an illustration of an operating device according to an exemplary embodiment.

FIG. 13 shows a schematic illustration of an actuator device according to an exemplary embodiment. and

FIG. 14 shows a flow chart for a method according to an exemplary embodiment.

The same or similar reference symbols are used for elements with similar functions in the following description of preferred exemplary embodiments, wherein the descriptions of these elements shall not be repeated.

### DETAILED DESCRIPTION

A magnetorheological medium, e.g. a magnetorheological fluid, can be advantageously used for a vehicle in combination with an operating device that has a moving handle. It is possible to set, in a nearly stepless manner, the force needed to move the handle via the magnetorheological medium.

An operating device for a vehicle has a moving handle for this, and an actuator device comprising a magnetorheological medium, which is coupled to the handle and designed to exert a setting force on the handle that is dependent on the viscosity of the magnetorheological medium.

The vehicle can be a motorized two-wheeled vehicle such as a motorcycle or a scooter, or some other type of land vehicle, aircraft, or water vehicle. A drive mechanism or braking mechanism in the vehicle can be operated via the operating device. The handle can be shaped such that the driver of the vehicle can move the handle by hand. By way of example, the handle can be grasped in the hand. The handle can be rotated and/or moved linearly. The handle can be or is connected to a part of the vehicle for this, e.g. handlebars, via a suitable bearing. Depending on the force required to move the handle, the handle can be set, e.g. such that it can be easily moved, or is difficult to move from the perspective of the driver, and by adjusting the viscosity of the magnetorheological medium, it can be set to nearly any intermediate stage. In this manner, the force required to move the handle can be adjusted to a current driving situation, to an operating functionality currently provided by the operating device, or to the preference of the vehicle operator. The magnetorheological medium can be a medium comprising magnetically polarizable particles. In particular, it can be a magnetorheological fluid (MRF), such as that already used for other vehicle applications. Alternatively, it can be a magnetorheological elastomer. The actuator device can be designed to set the viscosity of the magnetorheological medium through the strength of a magnetic field acting on the magnetorheological medium. The greater the viscosity, the greater the setting force can be.

In additions to functions such as accelerating and/or braking, the operating device can also, or alternatively, enable implementation of a launch control, in which the handle regulates the force of the user, such that the optimal torque can be made use of. Additionally or alternatively, the operating device can form a gearshift with which the user has the possibility of exceeding a defined force in one direction or the other to shift up or down.

The actuator device can be designed to set the viscosity of the magnetorheological medium using a setting signal. By adjusting the viscosity, a value for the setting force can be set. In this manner, a change in viscosity can result in a change in the setting force. By way of example, the setting signal can be used to operating a magnetic field generator in the actuator device, or to generate a signal for operating such a magnetic field generator. The setting force, and thus the actuating force required from the vehicle operator, can be quickly and easily set via the setting signal.

For this, the operating device can have a setting device that is designed to provide the setting signal. By way of example, the setting device can be configured to provide the setting signal using a speed signal indicating the speed of the vehicle. In this manner, the setting force can be set based on the speed of the vehicle. By way of example, the actuating force to be exerted by the vehicle operator can be increased as the speed of the vehicle increases. Additionally or alternatively, the setting device can be designed to provide the setting signal using a input speed signal indicating an input speed of the vehicle. The input speed can represent a speed specified by a cruise control, or a maximum speed for the vehicle, or it can represent a distance travelled by the vehicle. By way of example, the setting force can be abruptly increased upon reaching the input speed. As a result, the vehicle operator can be informed when the input speed is reached. Additionally or alternatively, the setting device can be designed to provide the setting signal using a rotational rate signal indicating a rotational rate of the vehicle's engine. By way of example, the setting force can be increased if the engine is no longer rotating within an optimal range with regard to fuel consumption or power output. This encourages the vehicle operator to operate the engine in an optimal range. Additionally or alternatively, the setting device can be designed to provide the setting signal using an input rotational rate signal that indicates an input rotational rate for the vehicle's engine. The input rotational rate can be a maximum rotational rate or an optimal rotational rate with respect to the operating properties of the vehicle or the engine.

According to one embodiment, the handle can be rotated in a first direction. The actuator device can be designed to exert the setting force for slowing rotation of the handle in the first direction on the handle. As a result, the actuator device can be used to adjust the movement of the handle in the first direction such that it can move easily, with difficulty, or not at all. By way of example, the vehicle's engine power output can be increased by rotating the handle in the first direction. In this manner, the functionality of an accelerator handle is obtained.

Additionally or alternatively, the handle can also be rotated in a second direction, opposite the first. Accordingly, the actuator device can be designed to exert the setting force on the handle for slowing a rotational movement of the handle in the second direction. The force for slowing the rotation in the second direction can differ from the force for slowing the rotation in the first direction, or both slowing forces can be the same. The second direction of rotation can be used, for example, to obtain an operating brake function.

The operating device can have a detector device that is designed to detect movement of the handle. The detector device can also be designed to provide a control signal for controlling a function of the vehicle on the basis of a value characterizing the movement. The detector device can contain a sensor for detecting movement, e.g. a Hall sensor. The control signal can be provided at an interface to a control unit in the vehicle, or at a vehicle bus. A functional unit in the detector device can also be implemented in a control unit. In this manner, the operating device can be incorporated in a vehicle control system.

By way of example, the detector device can be designed to detect a direction of the movement as the characterizing value. Different directions can be assigned different operating functions, such that the direction of movement can be used to determine which operating function is currently being used by the vehicle operator. Additionally or alternatively, the detector device can be designed to detect the speed of a movement as the characterizing value. By way of example, an abrupt movement can be assigned a different operating function than a smooth movement. Additionally or alternatively, the detector device can be designed to detect a temporal course of the movement as the characterizing value. The temporal course can indicate the length of a movement in one direction, or a change in the direction of movement. By way of example, a quicker change in direction can be assigned another operating function. A brief movement of the handle in one direction and an immediately subsequent movement in the other direction can indicate a desired gear shifting by the vehicle operator.

The detector device can therefore be designed to provide the control signal for controlling a vehicle's engine output. Additionally or alternatively, the detector device can be designed to provide the control signal for controlling a rotational rate of the vehicle's engine. In this manner, the functionality of an accelerator handle can be obtained. Additionally or alternatively, the detector device can be designed to provide the control signal for controlling the vehicle's speed. Additionally or alternatively, the detector device can be designed to provide the control signal for controlling a vehicle's acceleration. This results in a very comfortable control of the vehicle, e.g. in conjunction with an automatic transmission. Additionally or alternatively, the detector device can be designed to provide the control signal for controlling a vehicle transmission. This allows the vehicle operator to select an appropriate gear setting. Additionally or alternatively, the detector device can be designed to provide a control signal for controlling a vehicle's operating brake. This results in there being no need for a separate brake lever.

According to one embodiment, the actuator device can be designed to support the handle such that it can move. As a result, there is no need for a separate mechanical bearing.

A vehicle, in particular a motorized two-wheeled vehicle, can comprise an operating device specified above. By way of example, the operating device can be used in place of a conventional rotary handle in a vehicle.

A method for operating such a vehicle comprises the following steps:

setting the viscosity of the magnetorheological medium in the actuator device for the operating device in the vehicle;

obtaining a value that characterizes a movement of the handle in the operating device; and determining a control signal for controlling a vehicle function using the characterizing value.

The steps of the method can be implemented in an appropriate device that is part of the operating device or part of a control unit in the vehicle. Such a device can be an electric device that processes electric signals, e.g. sensor signals, and outputs corresponding control signals. The device can contain one or more interfaces in the form of hardware and/or software. A hardware interface can be part of an integrated circuit in which the functions of the device are implemented. The interfaces can also be composed of integrated circuits, or at least be composed of discreet components. Software interfaces can be software module interfaces on a microcontroller, in addition to other software modules.

A computer program containing program code that can be stored on a machine-readable medium such as a solid state memory, hard disk, or optical memory, and is used to execute the method according to any of the embodiments described above, when the program is executed on a computer or a device.

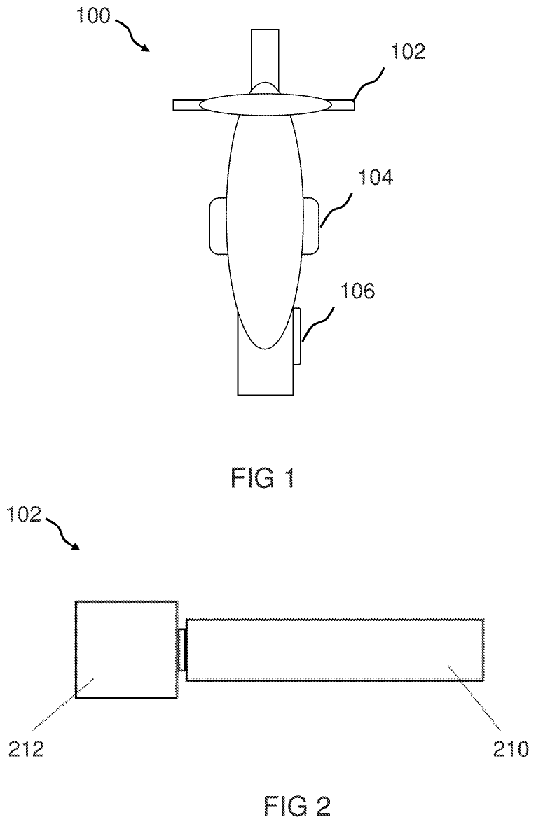

FIG. 1 shows a vehicle 100 with an operating device 102 according to an exemplary embodiment. The vehicle 100 is a motorcycle, merely by way of example. The vehicle 100 has handlebars in this exemplary embodiment. The operating device 102 is located at the right-hand end of the handlebars. The operating device 102 allows a driver to operate the vehicle 100, e.g. to control the power of the drive engine 104 in the vehicle 100. According to different exemplary embodiments, the operating device 102 also enables control of an operating brake 106 for the vehicle, and/or a vehicle 100 transmission. The operating device 102 is used in place of a conventional handle, and comprises a handle and an actuator device. According to this exemplary embodiment, the handle can be grasped by the hand of the driver of the vehicle 100, and rotated.

As an alternative to a motorcycle or scooter, the operating device 102 can also be used in conjunction with another land, air or water vehicle, e.g. a quad-bike, electric bicycle, or helicopter.

FIG. 2 shows a side view of an operating device 102 according to an exemplary embodiment. This can be an exemplary embodiment of the operating device shown in FIG. 1. The operating device 102 has a handle 210 and an actuator device 212. The handle 210 is supported such that it can move, e.g. by the actuator device 212 or an additional bearing device.

A housing for the actuator device 212 can be rigidly attached to the handlebars on the motorcycle shown in FIG. 1. The handle 210 can thus be moved in relation to the housing for the actuator device 212, and thus in relation to the handlebars.

The actuator device 212 is designed to exert an adjustable setting force on the handle 210. The setting force acts against a force exerted by a driver's hand on the handle 210 to move the handle 210. Depending on the strength of the setting force, the setting force may be barely noticeable, or it can be very noticeable. According to one exemplary embodiment, the handle 210 can be set at a maximum setting force from the perspective of the driver.

The actuator device 212 is also referred to as an MRF actuator. To set the setting force to a currently necessary value, the actuator device 212 contains a magnetorheological medium, e.g. a magnetorheological fluid. The viscosity of the magnetorheological medium can be altered. The setting force is obtained by the friction between the magnetorheological medium and the handle 210 or a shaft coupled to the handle 210. With a high viscosity of the magnetorheological medium, the magnetorheological medium according to one exemplary embodiment exerts a greater setting force on the handle 210 than with a lower viscosity.

The viscosity of the magnetorheological medium is set by a magnetic field acting on the magnetorheological medium according to one exemplary embodiment. The strength of the magnetic field can be adjusted to set the viscosity of the magnetorheological medium. The actuator device 212 comprises an electromagnet or a moveable permanent magnet for generating the magnetic field.

According to one exemplary embodiment, the actuator device 212 comprises a reset unit for the handle 210. This reset unit causes a mechanical and/or electronic return of the handle to the initial position.

The operating device 102 according to different exemplary embodiments enables fuel consumption and braking regulation in a motorcycle with variable haptics by means of an MRF actuator in the actuator device 212. The operating pattern is similar to that for traditional accelerators on motorcycles. The driver rotates the handle to accelerate. If the driver rotates the handle in the other direction, the motorcycle is slowed down.

According to one exemplary embodiment, the operating device 102 forms an accelerator handle, in which the handle 210 is coupled to an MRF actuator. This results in different haptics and locking. As a result, numerous operating functions can be executed with a rotary handle. Consequently, the system can lock the handle starting at a certain speed, e.g. in the 30 km/h range, such that it is not possible to drive faster. According to one exemplary embodiment, the locking is such that it is possible to overcome it by exerting more force, e.g. to allow for avoidance maneuvers in emergency situations. The operating device 102, also referred to as a rotary handle, can contain both the accelerator as well as the brakes. If the handle 210 is rotated in one direction, the vehicle accelerates. If the handle 102 is rotated in the other direction, the vehicle is braked.

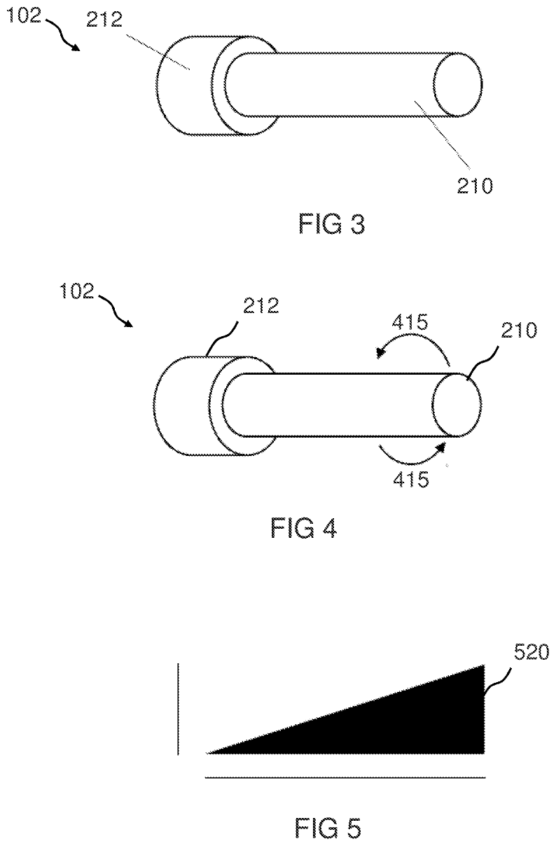

FIG. 3 shows a three dimensional illustration of an operating device 102 according to an exemplary embodiment. This is an illustration of the operating device described in reference to FIG. 2.

The handle 210 is cylindrical in this exemplary embodiment. The handle 210 has a free end. The end lying opposite the free end of the handle 210 is coupled to the actuator device 212. By way of example, the actuator device 212 has a cylindrical housing.

According to various exemplary embodiments, the handle 210 can rotate about is longitudinal axis, and/or be displaced along its longitudinal axis.

The handle 210 can be used as an accelerator handle, for controlling acceleration of the vehicle. The handle 210 can also exercise the functionality of a cruise control or speed limiter. According to one exemplary embodiment, the handle 210 can also be used to brake the vehicle or shift gears in the vehicle.

FIG. 4 shows an illustration of a movement of the handle 210 in an operating device 102 according to an exemplary embodiment. This can be the operating device described in reference to FIG. 3. The handle 210 is rotated in a first direction 415 therein. The rotational movement is caused, for example, by the movement of a driver's hand, in this case in the first direction.

Depending on the viscosity of the magnetorheological medium, the actuator device 212 imposes a more or less strong setting force on the handle 210. The setting force slows the rotation of the handle 210, in relation to the first direction here.

FIG. 5 shows a setting force curve 520 for an operating device as a function of the vehicle's speed, according to an exemplary embodiment. The vehicle speed is plotted on the x-axis, and the setting force exerted on the handle by the actuator device shown in FIG. 4, acting against the rotation of the handle in the first direction, is plotted on the y-axis. According to this exemplary embodiment, the value for the setting force is set as a function of the vehicle's speed. According to one exemplary embodiment, there is a predefined relationship between the value for the vehicle's speed and the value for the setting force, wherein the value for the setting force tends to increase as the vehicle's speed increases.

According to the exemplary embodiment shown here, there is a linear relationship between the value for the vehicle's speed and the value for the setting force. By way of example, the setting force at a starting speed of 10 km/h, for example, has a starting value of 0.5 Nm, for example, and increases, starting from this initial value to an end value of, e.g., 5 Nm at an end speed of 200 km/h.

According to this exemplary embodiment, the rotation of the handle in the first direction is used to accelerate the vehicle. The actuator device controls forces using the magnetorheological medium such that higher speeds result in higher forces necessary for rotating the handle.

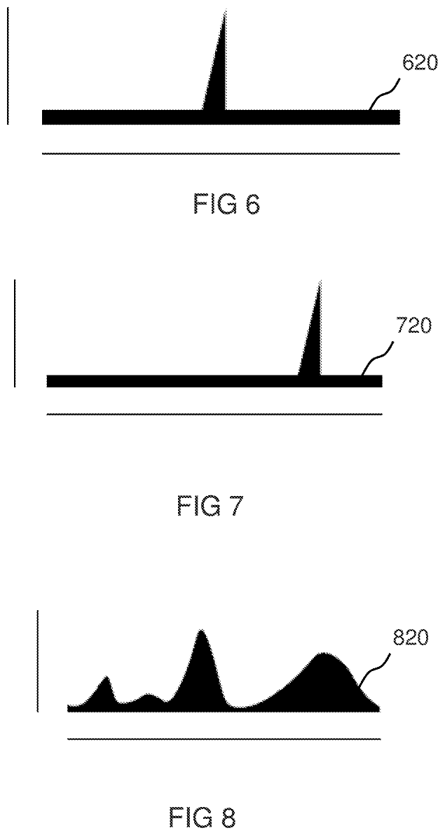

FIG. 6 shows a setting force curve 620 for an operating device as a function of the vehicle's speed, according to an exemplary embodiment. The vehicle's speed is plotted on the x-axis, and the setting force exerted on the handle by the actuator device shown in FIG. 4, acting against rotation of the hand in the first direction, is plotted on the y-axis. According to this exemplary embodiment, a value for the setting force is set as a function of the vehicle's speed. According to one exemplary embodiment, the setting force has a constant value over the speed range shown, aside from a peak at an input speed.

By way of example, the setting speed in a speed range of 10 km/h to 100 km/h, for example, has a starting value of 0.5 Nm. Shortly before reaching the input speed, e.g. at 50 km/h, the setting force increases to an end value of 5 Nm, for example. After reaching or exceeding the input speed, the setting force abruptly drops back to the starting value. The peak for the setting force, also referred to as a peak, has an expansion on the x-axis of less than 20% or less than 10% of the input speed.

According to this exemplary embodiment, the rotation of the handle in the first direction results in an acceleration of the vehicle, wherein the handle also assumes the function of a cruise control or speed limiter (English: speed limiter). The actuator device controls forces using the magnetorheological medium such that the force is very strong when a certain speed is reached, and an attempt is made to drive faster.

FIG. 7 shows a setting force curve 720 for an operating device as a function of the rotational rate of the engine, according to an exemplary embodiment. The engine rotational rate is plotted on the x-axis, and the setting force exerted on the handle by the actuator device shown in FIG. 4, and acting against the rotation of the handle in the first direction, is plotted on the y-axis. According to this exemplary embodiment, a value for the setting force is set as a function of the engine's rotational rate. According to one exemplary embodiment, the setting force has a constant value over the engine's rotational rate range, aside from a peak at an input engine rotational rate.

By way of example, the setting force in an engine's rotational rate range of 1,000 rpm to 14,000 rpm has a starting value of 0.5 Nm, for example. Shortly before reaching the input engine rotational rate, at 10,000 rpm, for example, the setting force increases to an end value of 5 Nm, for example. After reaching or exceeding the input engine rotational rate, the setting force drops abruptly back to the starting value. The peak of the setting force, also referred to as a peak, has an expansion in relation to the x-axis of less than 1% of the input engine rotational rate.

According to this exemplary embodiment, the rotation of the handle in the firs direction results in an increase in the rotational rate of an engine in the vehicle, wherein the handle also provides a kickdown functionality. The actuator device controls forces with the magnetorheological medium such that the rotational rate of the engine can be regulated with the handle up to a certain range. Starting at a threshold value, a resistance must be overcome, after which the full potential of the rotational rate is queried.

FIG. 8 shows a setting force curve 820 for an operating device as a function of the engine's rotational rate, according to an exemplary embodiment. The engine's rotational rate is plotted on the x-axis, and the setting force exerted on the handle by the actuator device shown in FIG. 4, and which acts against the rotation of the handle in the first direction, is plotted on the y-axis. According to this exemplary embodiment, a value for the setting force is set as a function of the engine's rotational rate. According to one exemplary embodiment, the setting force has a predetermined wave-shaped curve over the engine's rotational rate range shown herein.

By way of example, the setting force at a starting engine rotational rate of 1,000 rpm has a starting value of 0.5 N and at an end engine rotational rate of 14,000 rpm drops back to the starting value. The setting force curve 820 in between these points has more maximums, that have values lying between the starting value and an end value of 5 Nm, for example. By way of example, the setting force curve 820 has four maximums, only one of which reaches the end value for the setting force.

According to this exemplary embodiment, the handle is rotated in the first direction to increase the rotational rate of the engine in the vehicle, wherein the handle also provides a launch-control functionality. This functionality comprises a traction control that enables a technically optimized start-up of the vehicle.

The actuator device controls forces by using the magnetorheological medium such that the driver is provided with the optimal rotational rate range for an optimal start, and slippage is minimized.

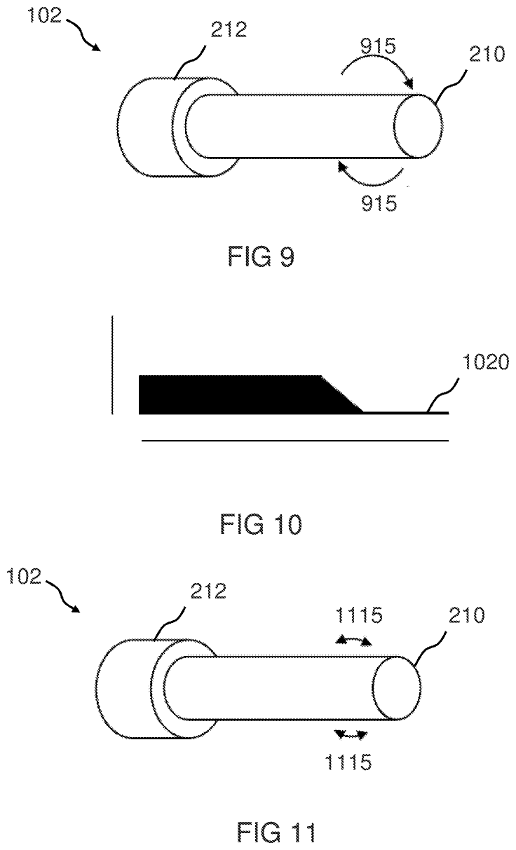

FIG. 9 shows an illustration of a movement of the handle 210 in an operating device 102 according to an exemplary embodiment. This can be the operating device described in reference to FIG. 3. The handle 210 is rotated in a second direction 915 therein, which is opposite the direction shown in FIG. 4. The rotation is caused, for example, but the movement of a driver's hand encompassing the handle 210.

The setting force required by the actuator device 212 for moving the handle 210 depends on the viscosity of the magnetorheological medium. The setting force slows the movement of the handle 210, in this case in relation to the second direction.

The actuator device 212 is designed provide the same or different setting forces for the different directions of rotation in different exemplary embodiments.

FIG. 10 shows a setting force curve 1020 for an operating device as a function of the vehicle's speed, according to an exemplary embodiment. The vehicle's speed is plotted on the x-axis, and the setting speed exerted on the handle by the actuator device in FIG. 9, and which acts counter to the rotation of the handle in the second direction, is plotted on the y-axis. The vehicle's speed decreases along the x-axis in this drawing. According to this exemplary embodiment, the value for the setting force is set as a function of the vehicle's speed. According to one exemplary embodiment, there is a predetermined relationship between the value for the vehicle's speed and the value for the setting force, wherein the setting force decreases when the speed falls below an emergency braking speed.

According to the exemplary embodiment shown therein, the setting force has a constant starting value of 2 Nm in a speed range lying between an end speed of 100 km/h and an emergency braking speed of 30 km/h, for example. When the speed falls below the end speed, the setting force drops in a linear manner to the end value of 0.5 Nm, for example, and subsequently remains at the end value until reaching a standstill at 0 km/h.

According to this exemplary embodiment, the handle is rotated in the second direction to brake the vehicle. The actuator device controls forces using the magnetorheological medium such that a braking in implemented by the opposing rotational movement. The rotational movement used for this is opposite the rotational movement in the first direction, which is used, for example, to accelerate, or increase the rotational rate. The system reacts in a manner specific to the situation for a braking. With an emergency braking, the forces are very low. As a result, only very low forces have to be overcome to rotate the handle further in the second direction, facilitating a further increase in the demand for braking forces.

FIG. 11 shows an illustration of a movement of a handle 210 for an operating device 102, according to an exemplary embodiment. This can be the operating device described in reference to FIG. 3. An alternating movement 1115 of the handle 210 is shown, composed of two brief, opposing, and directly successive rotational movements. The alternating movement 1115 is obtained with the movement of a driver's hand encompassing the handle 210.

The setting force required by the actuator device 212 for moving the handle 210 depends on the viscosity of the magnetorheological medium. The setting force slows the alternating movement 1115 of the handle 210, in this case in relation to both directions.

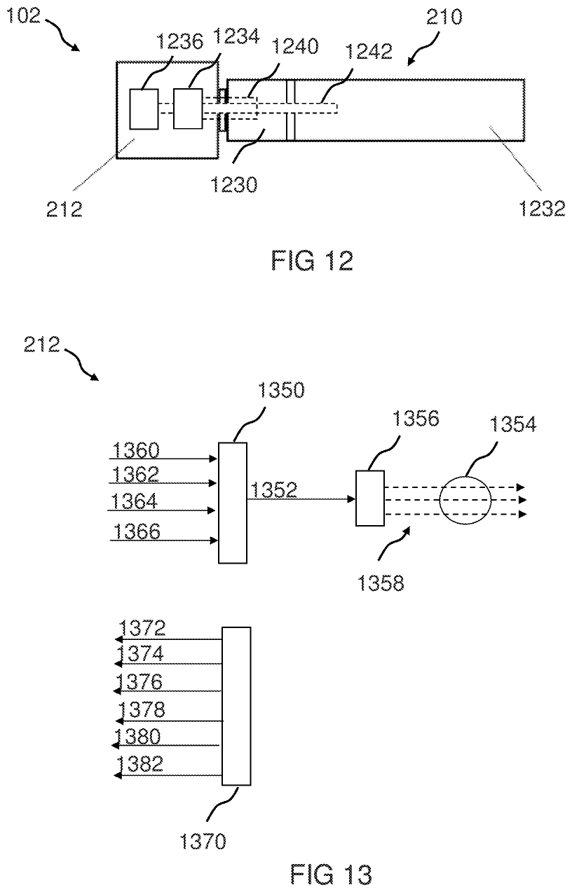

FIG. 12 shows an illustration of an operating device 102 according to an exemplary embodiment. Unlike the operating device described in reference to FIG. 3, the handle 210 on the operating device 102 shown in FIG. 12 has a first moving section 1230 and a second moving section 1232. The actuator device 212 contains a first actuator 1234 and a second actuator 1236, such that independent setting forces can be provided for the two independently moving handle sections 1230, 1232.

The first actuator 1234 has a first magnetorheological medium and is designed to exert a first setting force on the first handle section 1230 as a function of a viscosity of the first magnetorheological medium. The first actuator 1234 is coupled to the first handle section 1230 via a first shaft 1240 for this. The second actuator 1236 has a second magnetorheological medium and is designed to exert a second setting force on the second handle section 1232 as a function of a viscosity of the second magnetorheological medium. The second actuator 1236 is coupled to the second handle section 1232 via a second shaft 1242 for this.

By way of example, the first handle section 1230 can be shaped such that it can be operated by the thumb on the driver's hand. The second handle section 1232 can be shaped such that it can be operated by the driver's hand. As a result, the second handle section 1232 can be longer, e.g. more than four times as long as the first handle section 1230. The first handle section 1230 is located between the actuator device 212 and the second handle section 1232.

FIG. 13 shows a schematic illustration of an actuator device 212 according to an exemplary embodiment. The actuator device 212 can be used in combination with an operating device such as that shown in FIG. 3, for example.

According to one exemplary embodiment, the actuator device 212 optionally has a setting device 1350. The setting device 1350 is designed to provide a setting signal 1352, via which the viscosity of the magnetorheological medium 1354 used by an actuator in the actuator device 212 can be set. By way of example, the setting signal 1352 is provided at an interface to an electromagnet 1356 in the actuator device 212, and can set a value for the magnetic field 1358 generated by the electromagnet 1356 and acting on the magnetorheological medium 1354.

The setting device 1350 in different exemplary embodiments is designed to determine the setting signal 1352 using data relating to a state of the vehicle, that is controlled via the operating device. These data can be obtained from a sensor system or a control unit in the vehicle. By way of example, the setting device 1350 is designed to provide the setting signal 1352 using a speed signal 1360 indicating the vehicle's speed, and/or using an input speed signal 1362 indicating an input speed of the vehicle, and/or using a rotational rate signal 1364 indicating a rotational rate of the engine in the vehicle, and/or using an input rotational rate signal 1366 indicating an input rotational rate for an engine in the vehicle.

According to one exemplary embodiment, the actuator device 212 can also comprise, additionally or alternatively, an optional detector device 1370. The detector device 1370 is designed to detect a movement of the handle and provide a control signal for controlling a function of the vehicle using a value that is characteristic for the movement of the handle. The detector device 1370 contains, e.g. a sensor system, via which a direction of the movement of the handle, and/or a speed of the movement of the handle, and/or a temporal and/or spatial course of the movement are detected as the characteristic values. By way of example, the detector device 1370 is designed to provide an engine control signal 1372 for controlling the power of the vehicle's engine, and/or a rotational rate control signal 1374 for controlling a rotational rate of the vehicle's engine, and/or a speed control signal 1376 for controlling the speed of the vehicle, and/or an acceleration control signal 1378 for controlling an acceleration of the vehicle, and/or a shifting control signal 1380 for controlling the vehicle's transmission, and/or a brake control signal 1382 for controlling the vehicle's operating brakes.

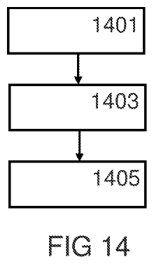

FIG. 14 shows a flow chart for a method according to an exemplary embodiment. The method is used for operating a vehicle that has an operating device such as that shown in FIG. 1.

A viscosity of the magnetorheological medium in the actuator device in the operating device in the vehicle is set in step 1401, e.g. by adjusting a magnetic field. A characteristic value is obtained in step 1403, which characterizes a movement of the handle on the operating device. The characteristic value is used in step 1405 to determine a control signal for controlling a function of the vehicle.

If an exemplary embodiment comprise an “and/or” conjunction between a first feature and a second feature, this can be read to mean that the exemplary embodiment according to one embodiment contains both the first and second feature, and according to another embodiment, contains either just the first feature or just the second feature.

### REFERENCE SYMBOLS

100 vehicle
102 operating device
104 drive engine
106 operating brakes
210 handle
212 actuator device
415 first direction of rotation
520 setting force curve
620 setting force curve
720 setting force curve
820 setting force curve
915 second direction of rotation
1020 setting force curve
1115 alternating direction
1230 first handle section
1232 second handle section
1234 first actuator
1236 second actuator
1240 first shaft
1242 second shaft
1350 setting device
1352 setting signal
1354 magnetorheological medium
1356 electromagnet
1358 magnetic field
1360 speed signal
1362 input speed signal
1364 rotational rate signal
1366 input rotational rate signal
1370 detector device
1372 engine control signal
1374 rotational rate control signal
1376 speed control signal
1378 acceleration control signal
1380 shifting control signal
1382 braking control signal
1401 setting step
1403 detecting step
1405 determining step

1. An operating device for a vehicle, the operating device comprising:
a moving handle; and
an actuator device comprising a magnetorheological medium,
wherein the actuator device is coupled to the handle and configured to exert a setting force dependent on a viscosity of the magnetorheological medium on the handle.

2. The operating device according to claim 1, wherein the actuator is configured to set the viscosity of the magnetorheological medium using a setting signal, in order to set a value for the setting force.

3. The operating device according to claim 2, wherein the operating device contains a setting device that is configured to provide the setting signal using a speed signal indicating the speed of the vehicle, and/or an input speed signal indicating the input speed of the vehicle, and/or a rotational rate signal indicating the rotational rate of the engine in the vehicle, and/or an input rotational rate signal indicating the input rotational rate of the engine in the vehicle.

4. The operating device according to claim 1, wherein the handle can move in a first direction of rotation, and the actuator device is configured to exert the setting force for slowing a rotational movement of the handle in the first direction on the handle, and/or the handle can move in a second direction that is opposite the first direction of rotation, to exert the setting force on the handle to slow a rotational movement of the handle in the second direction of rotation.

5. The operating device according to claim 1, wherein the operating device contains a detector device, configured to detect a movement of the handle and provide a control signal for controlling a function of the vehicle using a value that is characteristic for the movement.

6. The operating device according to claim 5, wherein the detector device is configured to detect a direction of the movement, and/or a speed of the movement, and/or a temporal or spatial course of the movement as the characteristic value.

7. The operating device according to claim 5, wherein the detector device is configured to provide the control signal for controlling the power of the vehicle's engine, and/or to control a rotational rate of the vehicle's engine, and/or to control a speed of the vehicle, and/or to control an acceleration of the vehicle, and/or to control a transmission in the vehicle, and/or to control a vehicle's operating brakes.

8. The operating device according to claim 1, wherein the actuator device is configured to support the handle such that it can move.

9. The operating device according to claim 1, wherein the handle has a first moving handle section and a second moving handle section, and the actuator device has a first actuator that contains a first magnetorheological medium, and a second actuator that contains a second magnetorheological medium, wherein the first actuator is coupled to the first handle section, and is configured to exert a first setting force on the first handle section that is dependent on a viscosity of the first magnetorheological medium, and wherein the second actuator is coupled to the second handle section, and configured to exert a second setting force on the second handle section that is dependent on a viscosity of the second magnetorheological medium.

10. A motorized two-wheeled vehicle comprising the operating device according to claim 1.

11. A method, wherein the method comprises the following steps:
setting a viscosity of a magnetorheological medium in an actuator device in an operating device for a vehicle;
obtaining a characteristic value that characterizes a movement of a handle on the operating device; and
determining a control signal for controlling a function of the vehicle using the characteristic value.

12. The method of claim 11, wherein the operating device comprising wherein the actuator device is coupled to the handle and configured to exert a setting force dependent on a viscosity of the magnetorheological medium on the handle.
